(19) United States
(12) Patent Application Publication
(10) Pub. No.: US 2009/0125993 A1
(43) Pub. Date: May 14, 2009

(54) METHOD FOR PROTECTING AGAINST KEYLOGGING OF USER INFORMATION VIA AN ALTERNATIVE INPUT DEVICE

(75) Inventors: Wayne M. Delia, Poughkeepsie, NY (US); Edward E. Kelley, Wappingers Falls, NY (US); Franco Motika, Hopewell Junction, NY (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/938,487

(22) Filed: Nov. 12, 2007

(51) Int. Cl. H04L 9/32

(52) U.S. Cl. 726/6

(57) ABSTRACT

A method for protecting against keylogging, the method includes: detecting from a host browser application, a request for a password input by a user of an alphanumeric input device in an entry field of a transaction; inserting a temporary indicator password in the entry field; sending an identifier of the host application with the temporary indicator password to an alternative device; retrieving a user assigned password stored in a table in the alternative device in response to matching the identifier of the host application and the temporary indicator password; sending the user assigned password to the host application; inserting the user assigned password in place of the temporary indicator password in the entry field; and sending the transaction to a server for verification and further processing.

### BACKGROUND OF THE INVENTION

1. Field of the Invention

The present invention relates generally to computer network security and, more particularly, to a method, article, and system for preventing password theft through unauthorized keylogging.

2. Description of the Related Art

Keylogging is a technological process of monitoring computer activity by recording, transmitting, and examining the characters typed on a computer keyboard. Employers monitoring employee productivity, typically involving clerical tasks sometimes use the keylogging technique. Other, more nefarious implementations of keylogging programs involve espionage, such as those embodied in spyware programs. These programs attempt to gather confidential information, such as a text string including an account name and password, and particularly a text string of keyboard strokes following input of a particular web site address. For example, a mouse click on a web browser icon displays the configured home page. A keyboard is used to enter a secure banking web site universal resource locator (URL) in the address input box. Following that, an account number and password are keyed in to the respective input fields. A malicious spyware program records the keystrokes entered on the keyboard, and that sequence of keystrokes is sent to an unknown third party for possible fraudulent use.

Keylogging programs, once installed and activated on a computer system, are extremely difficult to detect. Commercial and freeware spyware detection programs are available, but they are only useful against identified threats listed in the anti-spyware definitions file. However, standard anti-spyware detection programs may not identify new and more recent variations of spyware keylogger programs.

Keylogging programs generally work on the principle of detecting basic input/output system (BIOS) signals sent from what is assumed to be a standard keyboard layout (e.g., “QWERTY”, “DVORAK”, or other standard international keyboard layouts). Windows Vista and other popular operating systems and application software enable “re-mapping” of a computer keyboard. While this technique will thwart keyloggers, it is largely unused by the majority of computer users because the remapped keyboard departs from what is traditionally coordinated with the “muscle memory” of touch typists familiar with standard keyboard layouts. Other solutions to thwart keylogging involve displaying a keyboard on a monitor, from which input letters are selected with the mouse to enter the alphabetic and numeric characters in the input fields into the web form area that is used to contain the password. A variation of this method is to copy and paste the confidential information from a file. However, such approaches carry the risk of being defeated by hackers through the use of capturing and transmitting screen shots of completed forms, which are then analyzed for the confidential information.

### SUMMARY OF THE INVENTION

Embodiments of the present invention include a method for keylogging prevention, the method includes: detecting from a host browser application, a request for a password input by a user of an alphanumeric input device in an entry field of a transaction; inserting a temporary indicator password in the entry field; sending an identifier of the host application with the temporary indicator password to an alternative device; retrieving a user assigned password stored in a table in the alternative device in response to matching the identifier of the host application and the temporary indicator password; sending the user assigned password to the host application; inserting the user assigned password in place of the temporary indicator password in the entry field; and sending the transaction to a server for verification and further processing.

### TECHNICAL EFFECTS

As a result of the summarized invention, a solution is technically achieved for a method for keylogging prevention by generating an alternate input transaction on another device such as a cellular phone, personnel digital assistant, or any external peripheral device with alphanumeric entry and wireless or wired communication capability that is not susceptible to keylogging.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of an exemplary system for implementing embodiments of the invention.

FIG. 2 is a flowchart illustrating the anti keylogging measures according to embodiments of the invention.

The detailed description explains the preferred embodiments of the invention, together with advantages and features, by way of example with reference to the drawings.

### DETAILED DESCRIPTION

Embodiments of the invention provide a method for keylogging prevention by generating an alternate input transaction on another device such as a cellular phone, personnel digital assistant, or any external peripheral device with alphanumeric entry and wireless or wired communication capability that is not susceptible to keylogging. Embodiments of the invention bypass the keyboard of the device, such as a personnel computer (PC) that is the target of the keylogger programs that are able to steal confidential information. The alternative input devices provide transactional information, which includes a password or other confidential data to be input into fields that are to be shielded from key logger observation. The transaction is sent to the PC via, wired link, telephone call, cell phone call, infrared, bluetooth or similar technology.

Embodiments of the invention utilize a plug-in to a browser application on a PC that generates a transaction that is transmitted to an entry device, such as a cell phone or other alternative input devices. The browser plug-in facilitates the insertion of a password at the appropriate time and position in the browser application. The transaction requests a password from the entry device that is sent to the browser application. The password is subsequently inserted into the transaction page of the browser. The completed transaction page is sent from the PC browser to a server that processes the PC application. There are separate codes for each browser application, which is recognized by the cell phone or other alternative input devices when they receive the transaction request, that are recognized by the browser plug-in to seamlessly pass the password to the browser application.

Embodiments of the invention may also be used for any device such as cell phones, PDAs etc. that require a password, provided another device is available to create and send the transaction with the embedded password.

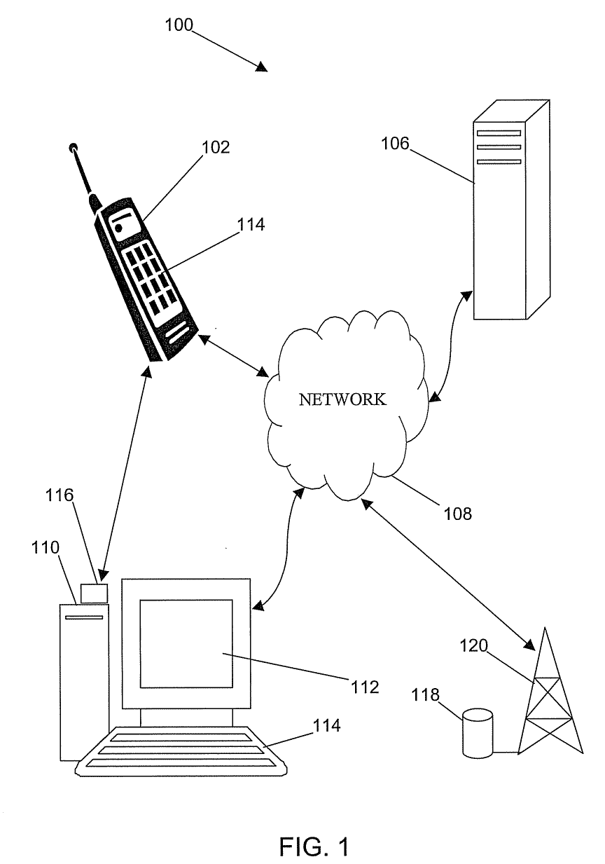

FIG. 1 is a block diagram of an exemplary system for implementing anti keylogging measures of embodiments of the invention. The system 100 includes remote devices 110, such as PCs, equipped with alphanumeric interfaces 114, such as keyboards, keypads, and touch screens, and displays 112 that facilitate graphical user interface (GUI) aspects for conducting transactions with a browser and associated plug-ins for carrying out aspects of embodiments of the invention. Alternative input devices 102 equipped with alphanumeric input interfaces 114 for implementing data entry and password requests, are in signal communication with remote device 110 through a communication interface 116. Depending on the type of alternative input device 102 and transmission method, the communication interface may be a two-way modem capable of receiving and transmitting information to wired and wireless devices, a bluetooth device, an infrared device, or other forms of transceivers. The remote devices 110 may be wirelessly connected to a network 108. The network 108 may be any type of known network including a local area network (LAN), wide area network (WAN), wireless local area network (WLAN), global network (e.g., Internet), intranet, etc. with data/Internet capabilities as represented by server 106. Communication aspects of the network are represented by cellular base station 118 and antenna 120.

Each remote device 110 may be implemented using a general-purpose computer executing a computer program for carrying out the GUI described herein. The computer program may be resident on a storage medium local to the remote devices 110, or maybe stored on the server system 106 or cellular base station 110. The server system 106 may belong to a public service. The remote devices 110 may be coupled to the server system 106 through multiple networks (e.g., intranet and Internet) so that not all remote devices 110 are coupled to the server system 106 via the same network. The remote devices 110, and the server system 106 may be connected to the network 108 in a wireless fashion, and network 108 may be a wireless network. In a preferred embodiment, the network 108 is a LAN and each remote device 110 executes a user interface application (e.g., web browser) to contact the server system 106 through the network 108. Alternatively, the remote devices 110 may be implemented using a device programmed primarily for accessing network 108 such as a remote client.

In an exemplary embodiment remote device 110 utilizes the network 108 to access an application that originates on server 106. A form generated by the GUI of the browser is presented on the display 112. The form is filled out on the remote device 110, and includes a temporary indicator password in place of a real password. Utilizing the filled out form, the browser plug-in builds a transaction, and sends the transaction to the alternative input device 102. The transaction contains the application name and password request. The alternative input device 102 will look up the application name in a table, and retrieve a password. The alternative input device 102 will return the application name and password to the remote device 110. The remote device 110 will then replace the temporary indicator password in the form with the password provided by the alternative input device 102. Subsequently, the remote device 110 sends the form via the network 108 to the server 106 for processing.

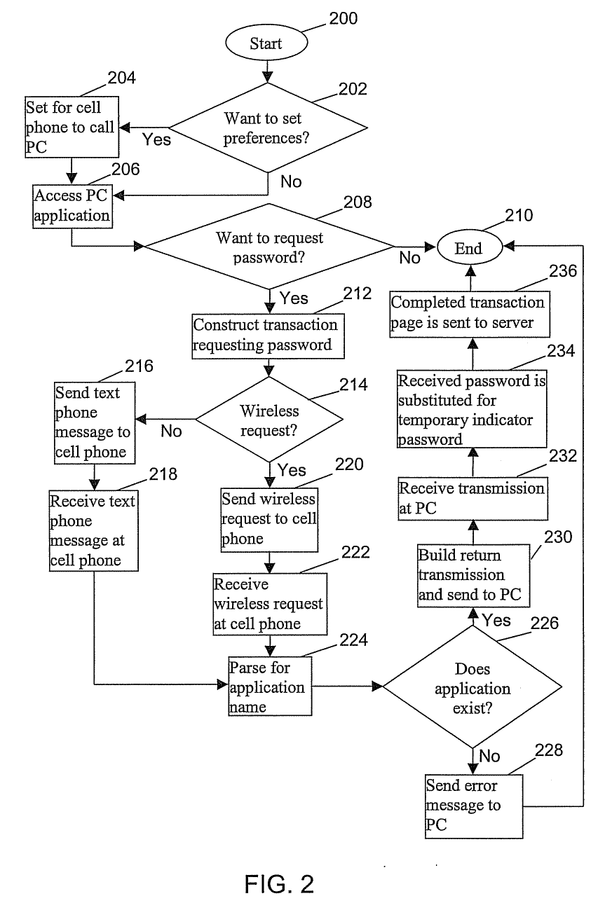

FIG. 2 is a flowchart illustrating the anti keylogging measures according to embodiments of the invention utilizing a PC for the remote device, and a cell phone for the alternative input device. The process starts (block 200) with a user setting a preference (decision block 202) for a cell phone call or a direct wireless cell phone communication with the PC. If a cell phone call is chosen (decision block 202 is Yes) the cell phone is set for a call from the PC (block 204). The PC application is accessed (block 206), and if a password is required (decision block 208 is Yes), a transaction is constructed (block 212) on the PC with an application name and a temporary indicator password. If the wireless connection to the cell phone was not selected (decision block 202 is Yes, decision block 214 is no) a text message is sent to the cell phone (block 216) that is received at the cell phone (block 218), and is then parsed for the application name (block 224). If a wireless connection to the cell phone was selected (decision block 202 is No, decision block 214 is Yes) a wireless text message request is sent to the cell phone (block 220), which is received at the cell phone (block 222) and parsed for the application name (block 224).

A determination is then made at the cell phone if the application exists in a table that consists of PC applications, associated passwords for each application, and associated temporary indicator passwords for each application. If the application name does not exist in the cell phone table (decision block 226 is No), an error message is sent to the PC (block 228) indicating that the application does not exist in the cell phone table. The user is then given the option to manually update the cell phone table with the application, the corresponding password, and the temporary indicator password. If however, the application name does exist on the cell phone table (decision block 226 is Yes), the cell phone builds and sends a return transmission to the PC that contains the application name, password, and temporary indicator password in a text format (block 230). The cell phone transmission is subsequently received at the PC (block 232), and the password obtained from the cell phone table is substituted for the temporary indicator password in the browser application transaction (block 234). The completed transaction request is then sent to the server for processing (block 236), and the process to protect the user password from keyloggers concludes (block 210).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

1-4. (canceled)

5. A method for preventing password theft through unauthorized keylogging, the method comprising:
receiving a user preference for connecting to an alternative device with a phone call or a direct wireless communication;
generating a host browser application password request;
generating a transaction that consists of a host browser application name and a temporary indicator password in an entry field;
sending the transaction to an alternative device;
wherein the alternative device is at least one of: a cellular phone, a personnel digital assistant, or any external peripheral device with alphanumeric entry and wireless or wired communication capability;
detecting from the host browser application, a request for a password input by the alternative device to be placed in the entry field of the transaction;
retrieving a user assigned password stored in a table in the alternative device in response to matching the host browser application name;
sending the transaction containing the alternative input device password and host browser application name back to the host browser application;
inserting the alternative device password into the host browser application to form a server transaction; and
sending the server transaction to a server for processing.

6. The method of claim 5, wherein a plug-in to the host browser application facilitates the insertion of the retrieved user assigned password at the appropriate time and position in the host browser application.

7. The method of claim 5, wherein the sending of the host browser application name, temporary indicator password, and user assigned password is by text messaging over a wireless link in the event the received user preference is the direct wireless communication.

8. The method of claim 5, wherein the sending of the host browser application name, temporary indicator password, and user assigned password is conducted through a text message sent via a telephone call in the event the received user preference is the phone call.
